(19) United States
(12) Patent Application Publication
(10) Pub. No.: US 2025/0240228 A1
(43) Pub. Date: Jul. 24, 2025

(54) BANDWIDTH MANAGEMENT WITH CONFIGURABLE PIPELINES IN A HIGH-PERFORMANCE COMPUTING ENVIRONMENT

(71) Applicant: CORNELIS NETWORKS, INC., WAYNE, PA (US)

(72) Inventors: Brent ROTHERMEL, WAYNE, PA (US); MIKE SHINKAROVSKY, WAYNE, PA (US); ALAN LANGDON, WAYNE, PA (US); GARY MUNTZ, WAYNE, PA (US)

(73) Assignee: CORNELIS NETWORKS, INC., WAYNE, PA (US)

(21) Appl. No.: 18/420,430

(22) Filed: Jan. 23, 2024

(51) Int. Cl. H04L 43/0823; H04L 47/74

(52) U.S. Cl. CPC H04L 43/0823; H04L 47/748

(57) ABSTRACT

Methods, systems, and products are provided for bandwidth management with configurable pipelines according to embodiments of the present invention. Embodiments include receiving, by a link manager during link negotiation and initialization, bandwidth capabilities of a link partner; establishing, by the link manager, a local receive bandwidth for a receive controller of a port in dependence upon the bandwidth capabilities of the link partner and the local port, and configuring, by the link manager of the switch, a pipeline in the receive controller of a port of the switch for processing data according to the receive bandwidth.

### BACKGROUND

High-Performance Computing (‘HPC’) refers to the practice of aggregating computing in a way that delivers much higher computing power than traditional computers and servers. In the context of HPC, network switches play a crucial role in facilitating communication between the various components of a cluster, such as servers, storage devices, and other networking equipment. Link negotiation and initialization (LNI) are important processes that occur when connecting switches to establish and configure network connections.

During link negotiation, devices exchange information about their capabilities, such as supported link speeds and lane widths. They then agree on a common configuration for the connection. Switches, like any other computing device, go through an initialization or boot process when they are powered on or rebooted. This process involves self-tests, hardware initialization, and loading of the system firmware. Switch ports need to be activated and configured according to the network's requirements. For HPC clusters, this often involves setting up high-speed, low-latency connections between the compute nodes and ensuring proper network segmentation.

Some current devices have the capability to bifurcate a port into two independent, fully functional ports. Incoming data into the receiver is processed at the supported bandwidth of the PHY. The core logic of the ASIC also supports the same maximum bandwidth. When a single port is bifurcated, two half-bandwidth ports replace one. Each of these ports has its own PHY which processes incoming data at full bandwidth, such that the total bandwidth fed to the ASIC core has doubled its capacity.

Distance rules define how many headers or header processing operations can be performed by a pipeline or switch core in a certain number of clock cycles. Legacy devices with lower bandwidth capabilities often employ narrower buses than newer devices, shifting the meaning of the rules.

There is a need for bandwidth management during LNI that can handle disparate bandwidth capabilities of link partners and also conform to distance rules.

### BRIEF DESCRIPTION OF THE DRAWINGS

Many aspects of the present disclosure can be better understood with reference to the following drawings.

FIG. 1 sets forth a system diagram of an example high-performance computing environment for bandwidth management according to embodiments of the present invention.

FIG. 2 sets forth a line drawing of a switch configured for bandwidth management according to example embodiments of the present invention.

FIG. 3 sets forth a block diagram of a compute node configured for bandwidth management according to embodiments of the present invention.

FIG. 4 sets forth a flowchart illustrating an example method for bandwidth management in a high-performance computing environment according to embodiments of the present invention.

FIG. 5 sets forth a line drawing illustrating bandwidth management with configurable pipelines according to embodiments of the present invention.

FIG. 6 sets forth a line drawing illustrating bandwidth management with configurable pipelines according to embodiments of the present invention.

### DETAILED DESCRIPTION

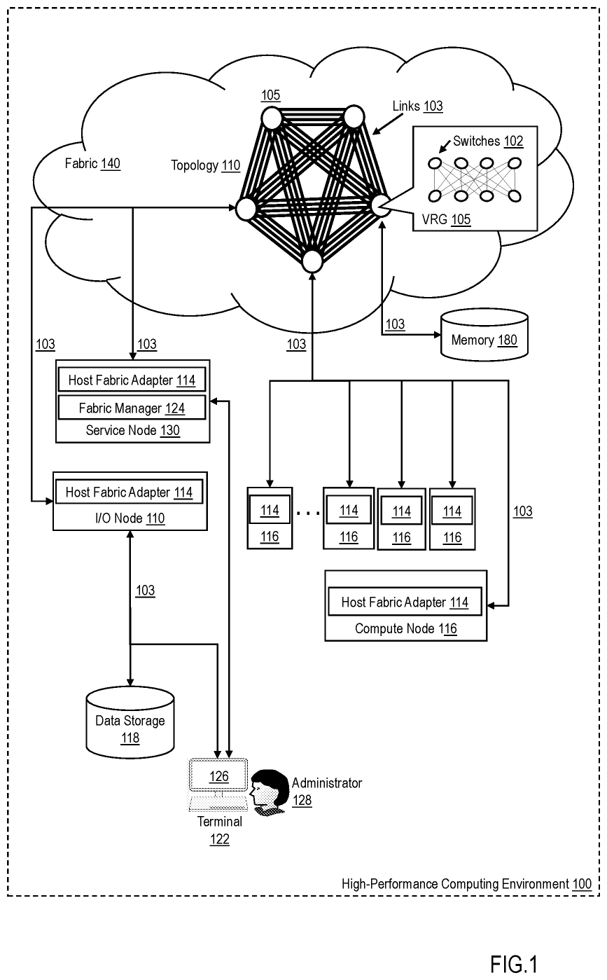

Methods, systems, devices, and products for bandwidth management with configurable pipelines in a high-performance computing environment according to embodiments of the present invention are described with reference to the attached drawings beginning with FIG. 1. FIG. 1 sets forth a system diagram of an example high-performance computing environment (100). The example high-performance computing environment of FIG. 1 includes an aggregation of a service node (130), an Input/Output (“I/O”) node (110), a plurality of compute nodes (116) each including a host fabric adapter (‘HFA’) (114). The example of FIG. 1 is a unified computing system that includes a fabric (140) of interconnected HFAs, links, and switches that often look like a weave or a fabric when seen collectively.

The HFAs (114), switches (102) and links (103) of FIG. 1 are arranged in a topology (110). A topology (110) is a wiring pattern among switches, HFAs, and other components and routing algorithms used by the switches to deliver packets to those components. Switches, HFAs, and their links may be connected in many ways to form many topologies, each designed to optimize performance for their purpose. Examples of topologies useful according to embodiments of the present invention include HyperX topologies, Dragonflies, Megaflies, Trees, Fat Trees, and many others. The example of FIG. 1 depicts a Megafly topology (110) which is an all-to-all connected set of virtual router groups (105). Virtual router groups (‘VRGs’) (105) are themselves a collection of switches (102) with their own topology—in this case a two-tiered tree.

The switches (102) of FIG. 1 are multiport modules of automated computing machinery, hardware and firmware, which receive and transmit packets. Typical switches receive packets, inspect packet header information, and transmit the packets according to routing tables configured in the switch. Often switches are implemented as, or with, one or more application specific integrated circuits (‘ASICs’). The hardware of the switch often implements packet routing and firmware of the switch configures routing tables, performs management functions, fault recovery, and other complex control tasks as will occur to those of skill in the art.

The switches (102) of FIG. 1 include a pipeline configured during LNI based upon the bandwidth capabilities of the link partners. During LNI, link partners exchange configuration information and each switch establishes a local receive bandwidth for a port and configures a pipeline in the receive controller to process data at the established receive bandwidth. The packet processing established by the configuration may also conform to distance rules such that legacy devices are accommodated both in bandwidth but also in distance rules for packet processing. Although discussed largely in the context of switches, potential link partners for bandwidth management according to embodiments of the present invention can be switch-to-switch, switch-to-HFA, or HFA-to-HFA as will occur to those of skill in the art.

The switches of FIG. 1 are configured for bandwidth management according to embodiments of the present invention by receiving configuration information from one or more potential link partners during LNI and establishing a local receive bandwidth value for a receive controller of a port in dependence upon local port configurations and port configurations of a link partner. The switches process data through a pipeline of the receive controller in dependence upon the established receive bandwidth value.

The switches and nodes of FIG. 1 are connected with links (103). Links (103) may be implemented as copper cables, fiber optic cables, and others as will occur to those of skill in the art. In some embodiments, the use of double density cables may also provide increased bandwidth in the fabric. Such double density cables may be implemented with optical cables, passive copper cables, active copper cables and others as will occur to those of skill in the art. Cables useful with embodiments of the present invention include QSFP-DD cables. QSFP-DD stands for Quad Small Form Factor Pluggable Double Density. The QSFP-DD complies with the IEEE802.3bs and QSFP-DD MSA standards.

The example of FIG. 1 includes a service node (130). The service node (130) of FIG. 1 provides services common to pluralities of compute nodes, loading programs into the compute nodes, starting program execution on the compute nodes, retrieving results of program operations on the compute nodes, and so on. The service node in FIG. 1 runs a service application and communicates with administrators (128) through a service application interface (126) that runs on a computer terminal (122).

The service node (130) of FIG. 1 has installed upon it a fabric manager (124). The fabric manager (124) of FIG. 1 is a module of automated computing machinery for configuring, monitoring, managing, maintaining, troubleshooting, and otherwise administering elements of the fabric (140). The example fabric manager (124) is coupled for data communications with a fabric manager administration module with a user interface (‘UI’) (126) allowing administrators (128) to configure and administer the fabric manager (124) through a terminal (122) and in so doing configure and administer the fabric (140).

The compute nodes (116) of FIG. 1 operate as individual computers including at least one central processing unit (‘CPU’), volatile working memory and non-volatile storage. The compute nodes are connected to the switches (102) and links (103) through a host fabric adapter (114). The hardware architectures and specifications for the various compute nodes vary and all such architectures and specifications are well within the scope of the present invention as will occur to those of skill in the art. Such non-volatile storage may store one or more applications or programs for the compute node to execute.

Each compute node (116) in the example of FIG. 1 has installed upon it or is connected for data communications with a host fabric adapter (114) (‘HFA’). Host fabric adapters according to example embodiments of the present invention deliver high bandwidth and increase cluster scalability and message rate while reducing latency. The HFA adapts packets from the node for transmission through the fabric maximizing scalability and performance. The HFAs of FIG. 1 are also configured for bandwidth management according to embodiments of the present invention. The HFAs of FIG. 1 also include a configurable pipeline for processing data at a receive bandwidth established during LNI according to embodiments of the present.

The example of FIG. 1 includes an I/O node (110) responsible for input and output to and from the high-performance computing environment. The I/O node (110) of FIG. 1 is coupled for data communications to data storage (118) and a terminal (122) providing information, resources, UI interaction and so on to an administrator (128).

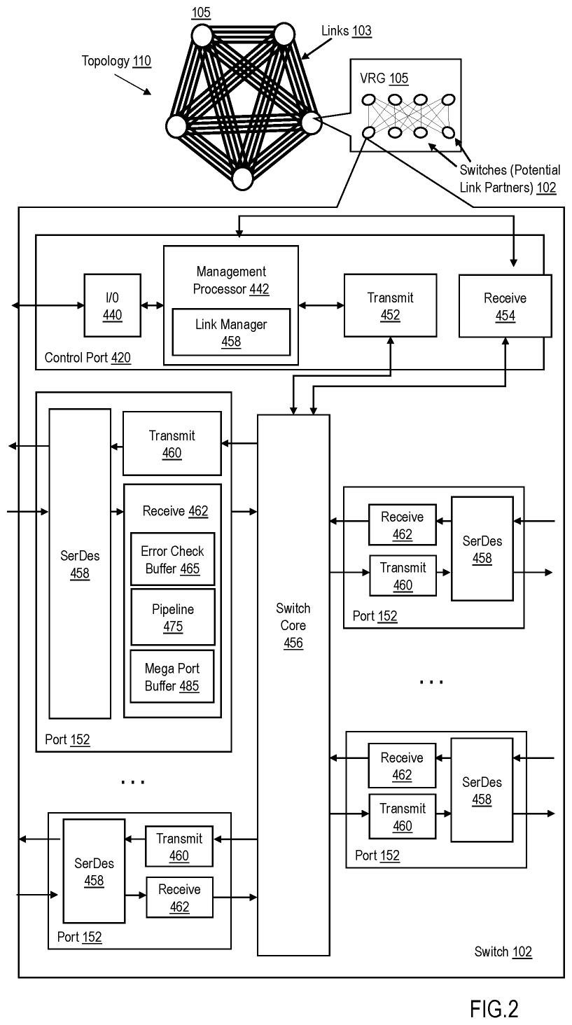

For further explanation, FIG. 2 sets forth a block diagram of an example switch capable of bandwidth management according to embodiments of the present invention. The example switch (102) of FIG. 2 includes a control port (420), a switch core (456), and a number of ports (152). Each port (152) is coupled with the switch core (456), a transmit controller (460), a receive controller (462), and a SerDes (458). The control port (420) of FIG. 2 includes an input/output (‘I/O’) module (440), a management processor (442), a transmit controller (452), and a receive controller (454). The management processor (442) of the example switch of FIG. 2 maintains and updates routing tables for the switch. In the example of FIG. 2, each receive controller maintains the latest updated routing tables. Management processors may be centrally located and shared by multiple or all ports, as shown, or per port (or both-a central processor and per port processors) as will occur to those of skill in the art.

The management processor (442) of FIG. 2 includes a link manager (458). The link manager of FIG. 2 is configured for bandwidth management according to embodiments of the present invention. The link manager of FIG. 2 includes logic configured to establish, during link negotiation and initialization, a local receive bandwidth value for a receive controller of a port in dependence upon local port configurations and port configurations of a link partner and configuring, by the link manager (458) of the switch, a pipeline (475) in the receive controller of the switch for processing data at the receive bandwidth. Configuring the pipeline includes setting up registers and buffers in the pipeline according to packet processing rules such that data is provided to the switch core at the established receive bandwidth.

The switch (102) of FIG. 2 includes a receive controller (462). The receive controller (462) is responsible for managing incoming data. The receive controller (462) of FIG. 2 includes an error check buffer (465), a pipeline (475), and a mega port buffer (485). The error check buffer (465) within the receive controller (462) is a component designed to perform checks on the received data to ensure its accuracy and integrity. The error check buffer includes mechanisms for error detection and correction employing techniques such as checksums, cyclic redundancy checks (CRC), parity bits, or other error-detection algorithms. If any errors are detected, the buffer may correct them using error correction techniques or signal that the data is corrupt.

The pipeline (475) is logic that processes data from the error check buffer to the mega port buffer (485) to handle incoming data packets. Pipelines are optimized for parallel processing and can handle multiple packets simultaneously. They are designed to process packets quickly and reliably, which is crucial for high-speed data transmission and low-latency networking.

The pipeline (475) of FIG. 2 includes logic configured to process flits of data from the error check buffer (465) to the mega port buffer (485) in dependence upon the receive bandwidth value. In high-performance computing (HPC), a “flit” is a term used to describe the smallest unit of data that can be transferred between components within a computer system, particularly in the context of computer networks and interconnects. The term “flit” is short for “flow control digit” or “flow control unit.” A flit can represent a fixed-size portion of a packet or message, and it typically carries control information, such as flit type including header, body, tail, and control flit. Flits are often used in the design of high-speed network routers and switches to efficiently route data within a computer cluster or a supercomputer.

The pipeline (475) of FIG. 2 is configurable with logic focusing on header flits, other logic on tail flits, and other processing of packet data. The pipeline includes registers and buffers that may be configured during LNI such that data is processed through the pipeline according to packet processing rules at the established receive bandwidth. The pipeline of FIG. 2 is configured to process flits of data from the error check buffer (465) to the mega port buffer (485) according to packet processing rules. Packet processing rules are one or more rules governing the manner in which data is processed in the pipeline and in which the mega port buffer is populated. These rules are defined based on the specific hardware architecture, technology, and design of the switch meeting the requirements for latency, throughput, and overall network performance.

In addition to being configured for an established receive bandwidth, the pipeline (475) is configured for distance rules. Distance rules define how many operations of a particular type (such as header operations or tail operations) can be performed by the pipeline or switch core in a certain number of clock cycles. They are essential for efficient and predictable packet processing in switches according to the present invention. Examples of distance rules include the rules specifying how many headers or header processing operations can be executed in a single clock cycle, how many tail or trail processing operations can be executed in a single clock cycle, how many clock cycles it takes for a packet to pass through each stage of the pipeline, how deep the packet processing (the maximum number of header processing stages a packet can traverse) and others as will occur to those of skill in the art. Distance rules may also define the level of parallelism, indicating how many headers can be processed simultaneously. For instance, a network processor might process two headers in parallel during each clock cycle.

The mega port buffer (485) of FIG. 2 is a buffer that receives data processed by the pipeline for transmission to the switch core (456). The mega port buffer (485) is designed for the data consumption configurations of the switch ASIC and is populated with data conforming to the processing rules and the distance rules of the ASIC.

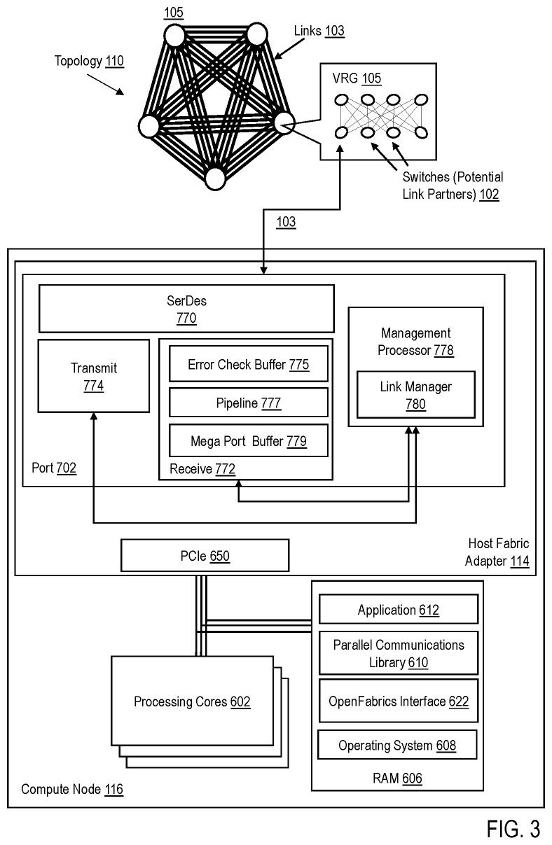

HFAs may also be configured for bandwidth management according to the present invention. FIG. 3 sets forth a block diagram of a compute node including a host fabric adapter (114) according to embodiments of the present invention. The compute node (116) of FIG. 3 includes processing cores (602), random access memory (‘RAM’) (606) and a host fabric adapter (114). The example compute node (116) is coupled for data communications with a fabric (140) through a link (103) configured according to the present invention.

Stored in RAM (606) in the example of FIG. 3 is an application (612), a parallel communications library (610), an OpenFabrics Interface module (622), and an operating system (608). Applications for high-performance computing environments, artificial intelligence, and other complex environments are often directed to computationally intense problems of science, engineering, business, and others. A parallel communications library (610) is a library specification for communication between various nodes and clusters of a high-performance computing environment. A common protocol for HPC computing is the Message Passing Interface (‘MPI’). MPI provides portability, scalability, and high-performance. MPI may be deployed on many distributed architectures, whether large or small, and each operation is often optimized for the specific hardware on which it runs.

OpenFabrics Interfaces (OFI), developed under the OpenFabrics Alliance, is a collection of libraries and applications used to export fabric services. The goal of OFI is to define interfaces that enable a tight semantic map between applications and underlying fabric services. The OFI module (622) of FIG. 3 packetizes the message stream from the parallel communications library for transmission.

The compute node of FIG. 3 includes a host fabric adapter (HFA) (114). The HFA includes a PCIe interconnect (650) and a fabric port (702). The fabric port (702) includes a management processor (778), a SerDes (770); a receive controller (772) and a transmit controller (774). The receive controller (772) includes an error check buffer (775), a pipeline (777), and a mega port buffer (779). The pipeline (777) of FIG. 3 operates in the same manner as the pipeline (475) of the switch of FIG. 2.

The management processor (778) includes a link manager (780), logic configured to receive bandwidth capabilities of a link partner during LNI and establishing a local receive bandwidth for a receive controller of a port in dependence bandwidth capabilities of a link partner. Management processors may be centrally located and shared by multiple or all ports, as shown, or per port (or both-a central processor and per port processors) as will occur to those of skill in the art. The link manager of FIG. 3 configures the pipeline (777) in the receive controller of the switch for processing data at the receive bandwidth. The so configured pipeline processes data into the mega port buffer (779) according to the established receive bandwidth.

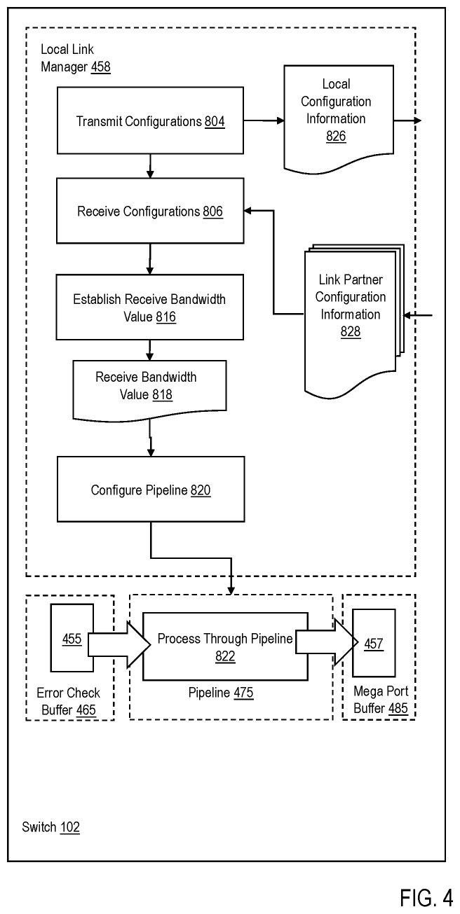

For further explanation, FIG. 4 sets forth a flow chart illustrating an example method of bandwidth management according to embodiments of the present invention. As mentioned above, during LNI, switches and HFA's exchange information about their capabilities and establish a common configuration for the connection. As mentioned above, potential link partners can be switch-to-switch, switch-to-HFA, or HFA-to-HFA as will occur to those of skill in the art. Negotiated configuration parameters include supported speeds, flow control mechanisms, error handling and detection parameters, and other parameters.

The method of FIG. 4 includes transmitting (804), by a link manager (458) to one or more potential link partners (102), local configuration information (826) and receiving (806), by a link manager (458) from one or more potential link partners (102), configuration information (828) of the one or more potential link partners. The configuration information includes bandwidth capabilities of potential link partners. In some embodiments, the bandwidth capabilities exchanged may be established by port bifurcation or the native configurations of one or more of the link partners.

The method of FIG. 4 includes establishing (816), by a link manager (458), a local receive bandwidth value (818) for a receive controller of a port in dependence upon local port configurations and port configurations of a link partner such as, for example, capabilities of the link partner and the capabilities of the local port. The receive bandwidth value so established is the lower of the supported bandwidths. As such, if the receiving ports bandwidth capabilities exceed those of the transmitting link partner, the receive bandwidth is established based on the partner.

The receive bandwidth of the method of FIG. 4 may be implemented as a number of flow control units (flits) per clock cycle. Such a receive bandwidth value may be two flits per clock cycle, four flits per clock cycle, eight flits per clock cycle, and so on as will occur to those of skill in the art. Flits themselves may be a particular size based upon the design and architecture of the system.

The method of FIG. 4 includes configuring (820), by the link manager of the switch or HFA, a pipeline in the receive controller of the port for the receive bandwidth. Configuring the pipeline for the receive bandwidth may be carried out by configuring registers and buffers according to packet processing rules such the pipeline populates a mega port buffer with a flits of data in accordance with the receive bandwidth and the processing capabilities of the pipeline and switch/HFA core.

The method of FIG. 4 also includes processing (822) data (455 and 457) through a pipeline (475) of the receive controller in dependence upon the established receive bandwidth value (818). Processing data through a pipeline (475) to a mega port buffer (485) in dependence upon established receive bandwidth value may be carried out by populating the mega port with flow control units (flits) according to packet processing rules, and often, distance rules.

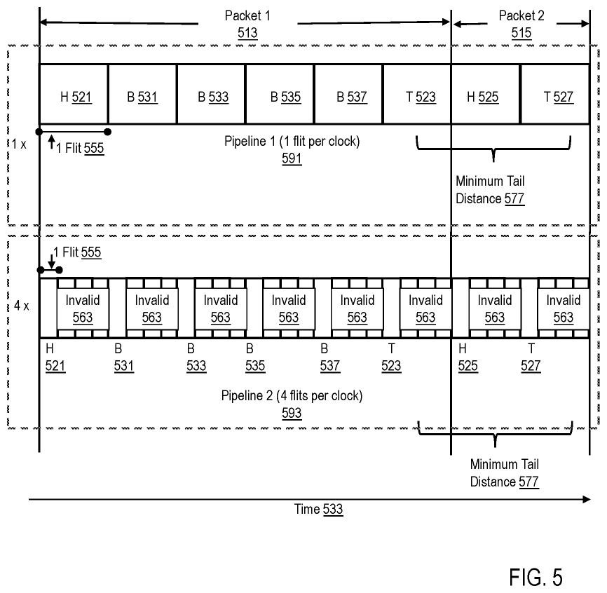

For further explanation, therefore, FIG. 5 sets forth a line drawing illustrating bandwidth management with distance rules according to embodiments of the present invention. The example of FIG. 5 illustrates two packets, Packet 1 (513) and Packet 2 (515), processed through two pipelines, Pipeline 1 (591) and Pipeline 2 (593). Pipeline 1 (591) has a bandwidth capability of 1 flit per clock. Pipeline 2 (593) supports a receive bandwidth of 4 flits per clock. In the example of FIG. 5, each tick mark designates a flit (555). In this example, Pipeline 2 (593) is capable of processing 4 flits in the same time as Pipeline 1 (591) processes 1 flit. Pipeline 2 could be a newer, higher-bandwidth device's receive pipeline, compared to the receive pipeline bandwidth of a legacy device as illustrated by Pipeline 1.

Properly processing the packets (513 and 515) through both pipelines (591 and 593) requires conforming to a minimum distance rule (577) while meeting or exceeding the bandwidth of the incoming data. As mentioned above, legacy devices (typically with lower bandwidth capabilities) often support shorter distance rules. In this example, pipeline 1 (591) requires a minimum distance (number of clock cycles) between tail operations.

To manage the bandwidth according to the present invention, Pipeline 2 (593) is configured to accommodate both the bandwidth capability and the distance rule (577) of the link partner. To do so, Pipeline 2 (593) has flit slots that may be set to valid or invalid, with each flit slot representing 1 flit bandwidth capability. A valid flit spot processes a flit of data through the pipeline. An invalid flit spot does not receive or process data, effectively shifting the packet data to valid flit spots. Pipeline 2 (593) of FIG. 5 has ¾ of its flit slots invalidated (563) thereby effectively throttling the receive bandwidth to 1 flit per clock.

The valid flit slots of Pipeline 2 contain the flit data of Packet 1 (513) and Packet 2 (515) and conform to the required minimum distance rule (577). Pipeline 2 has the flit data of the header (521) in a first valid flit slot, which is followed by three invalid flit slots. The next valid flit slot contains flit data from body (531) which is also followed by three invalid flit slots. This pattern of valid and invalid flit slots continues with valid flit slots containing flit data from body (533), body (535), body (537), tail (523), header (525), and tail (527). The valid flit slots so configured provide a receive bandwidth of 1 flit per clock and also properly populate the mega port buffer according to the distance rules.

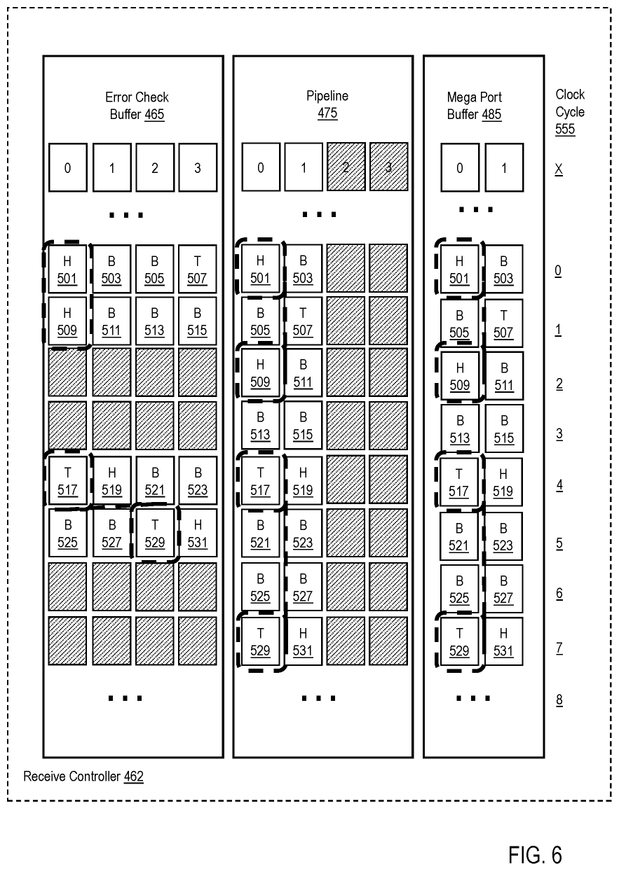

For further explanation, FIG. 6 sets forth a block diagram of a receive controller (462) conceptually illustrating the operations of a pipeline configured for bandwidth management according to embodiments of the present invention. The receive controller (462) of FIG. 6 includes an error check buffer (465), a pipeline (475), a mega port buffer (485), and a clock (555). The native capabilities of the port and its receive controller support a receive bandwidth of four flits per clock cycle. The error check buffer (465) of FIG. 6 therefore is illustrated with four flit slots (0-3).

In the example of FIG. 6, the local bandwidth capabilities of the pipeline (475) exceed those of the link partner, but the local distance rules are more constrained than its link partner. The receive controller of FIG. 6 supports a local native bandwidth capability of four flits per clock cycle. The link partner, however, is capable of processing only two flits per clock cycle. In the example of FIG. 6, therefore the receive bandwidth established for this port is that of the link partner-two flits per clock cycle. The example of FIG. 6 employs two local distance rules. One rule prohibits more than one header operation on the same or adjacent clock cycle and one rule prohibits more than one tail operation on the same or adjacent clock cycle.

The pipeline (475) of FIG. 6 is configurable according to embodiments of the present invention. The pipeline is illustrated to demonstrate that the pipeline may be configured to support up to four flit slots (0-3) (the full native capabilities of the port) but may be configured to populate the mega port buffer (485) with less than four flits per clock cycle. To illustrate the configuration of the pipeline conceptually, flit slot 0 and 1 are configured as valid and flit slots 2 and 3 are configured set as invalid and illustrated in pattern fill.

In this example, data arrives in the error check buffer (465) in bursts such that flits (501-515) are available for processing by the pipeline on clock cycle 0 and clock cycle 1. The pipeline (475) is configured to populate the mega port buffer (485) according to an established receive bandwidth of two flits per clock cycle. As such, flit (501) and flit (5103) are processed through the pipeline into the mega port buffer (485) for clock cycle 0. Flit (505) and flit (507) are similarly processed through pipeline to populate the mega port buffer (485) for clock cycle 1. Flit (509) and flit (511) populate two slots for the clock cycle 2. Flits (513 and 515) populate two slots for clock cycle 3.

The pipeline of FIG. 6 populates the mega port buffer in a manner that conforms to the distance rules. According to the rules of FIG. 6, no two header or tail operations may occur within two clock cycles. Although the data in the error check buffer does not comply with the header distance rule, the data is processed through the pipeline to conform with the rules. In this example, header (501) and header (509) are not in the mega port buffer to be processed on the same or adjacent clock cycles. Due to the configuration of the pipeline, flit (501) is processed on clock cycle 0 and flit (509) is processed on clock cycle 2.

In the example of FIG. 6, another burst of data including flits (517-531) is available for processing by the pipeline on clock cycle 4 and clock cycle 5. Flit (517) is a tail, flit (519) is a header, flits (521, 523, 525, 527) are bodies, flit (529) is a tail and flit (531) is a header. In the example of FIG. 6, flit (517) and flit (519) are processed into the mega port buffer (485) for clock cycle 4. Flit (521) and flit (523) are similarly processed through pipeline to populate the mega port buffer (485) for clock cycle 5. Flit (525) and flit (527) populate two slots for the clock cycle 6. Flits (529 and 531) populate two slots for clock cycle 7.

The pipeline of FIG. 6 populates the mega port buffer in a manner that conforms to the distance rules. According to the rules of FIG. 6, no two header or tail operations may occur within two clock cycles. Although the data in the error check buffer does not comply with the tail distance rule, the data is processed through the pipeline to conform with the rules. In this example, tail (517) and header (529) are not processed on the same or adjacent clock cycles. Due to the configuration of the pipeline, flit (517) is processed on clock cycle 4 and flit (529) is processed on clock cycle 7.

Those of skill in the art will recognize that the bandwidth and distance rules used in the examples of FIGS. 5 and 6 are for explanation and not for limitation. Devices with various bandwidth capabilities using various distance rules may be adapted for bandwidth management according to embodiment of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of bandwidth management in a high-performance computing environment, the method comprising;
receiving, by a link manager during link negotiation and initialization, bandwidth capabilities of a link partner;
establishing, by the link manager, a local receive bandwidth for a receive controller of a port in dependence upon the bandwidth capabilities of the link partner and the local port, and
configuring, by the link manager, a pipeline in the receive controller of a port of the switch for processing data according to the receive bandwidth.

2. The method of claim 1 further comprising processing, by the pipeline of the receive controller, data in dependence according to the established receive bandwidth.

3. The method of claim 2 wherein processing data through a pipeline of the receive controller in dependence upon the established receive bandwidth further comprises:
receiving data in an error check buffer;
processing data from the error check buffer to a mega port buffer through the pipeline in dependence upon established receive bandwidth.

4. The method of claim 1 wherein the receive bandwidth value comprises a number of flow control units (flits) per clock cycle.

5. The method of claim 4 wherein populating the mega port with flits according to the established receive bandwidth further comprise populating the mega port buffer with flits according to packet processing rules.

6. The method of claim 5 wherein the packet processing rules comprise distance rules.

7. A switch, the switch comprising:
a plurality of ports including a transmit controller and a receive controller, wherein the receive controller includes an error check buffer, a configurable pipeline, and a mega port buffer;
a switch core; and
a control port comprising a management processor, wherein the management processor comprises a link manager comprising logic configured to establish, during link negotiation and initialization, a receive bandwidth in dependence upon local port configurations and port configurations of a link partner and configure the pipeline to process data according to the receive bandwidth.

8. The switch of claim 7 wherein the pipeline comprises logic configured to move flits of data from the error check buffer to the mega port buffer according to the receive bandwidth value.

9. The switch of claim 8 wherein the pipeline is further configured to move flits of data from the error check buffer to the mega port buffer according to packet processing rules.

10. The switch of claim 9 wherein the packet processing rules comprise distance rules.

11. A host fabric adapter, the host fabric adapter comprising:
at least one fabric port comprising a management processor, a serializer/deserializer; a receive controller and a transmit controller; wherein the receive controller includes an error check buffer, a pipeline, and a mega port buffer;
wherein the management processor comprises a link manager comprising logic configured to establish, during link negotiation and initialization, a receive bandwidth in dependence upon local port configurations and port configurations of a link partner and configure the pipeline to process data according to the receive bandwidth value.

12. The host fabric adapter of claim 11 wherein the pipeline comprises logic configured to move flits of data from the error check buffer to the mega port buffer according to the receive bandwidth value.

13. The host fabric adapter of claim 12 wherein the pipeline is further configured to move flits of data from the error check buffer (775) to the mega port buffer (779) in compliance with packet processing distance rules.

14. A system of bandwidth management in a high-performance computing environment, the system comprising;
means for receiving, during link negotiation and initialization, bandwidth capabilities of a link partner;
means for establishing a local receive bandwidth for a receive controller of a port in dependence upon the bandwidth capabilities of the link partner and the local port, and
means for configuring a pipeline in the receive controller of a port of the switch for processing data according to the receive bandwidth.

15. The system of claim 14 further comprising means for processing data in dependence according to the established receive bandwidth.

16. The system of claim 15 wherein means processing data in dependence upon the established receive bandwidth further comprises:
means for receiving data in an error check buffer;
means for processing data from the error check buffer to a mega port buffer through the pipeline in dependence upon established receive bandwidth.

17. The system of claim 16 wherein the receive bandwidth value comprises a number of flow control units (flits) per clock cycle.

18. The system of claim 17 wherein means for populating the mega port with flits according to the established receive bandwidth further comprise means for populating the mega port buffer with flits according to packet processing rules.

19. The system of claim 18 wherein the packet processing rules comprise distance rules.
